(19) United States
(12) Patent Application Publication
(10) Pub. No.: US 2012/0066910 A1
(43) Pub. Date: Mar. 22, 2012

(54) ROTATING UTILITY KNIFE SCRAPER

(76) Inventor: Totada R. Shantha, Stone Mountain, GA (US)

(21) Appl. No.: 13/302,601

(22) Filed: Nov. 22, 2011

(51) Int. Cl. B26B 1/02; B26B 5/00

(52) U.S. Cl. 30/122

(57) ABSTRACT

A multi-use knife scraper has a handle portion which pivotally retains a blade holder at one end. A single-edged blade is held therein and can be positioned between a knife position which is generally parallel to the handle and a scraper position which is generally perpendicular to the handle. In one embodiment, the blade can be rotated to fit within the handle to secure the blade safely. One embodiment uses single-edged razor blades and another embodiment utilizes utility blades. The knife position allows the knife to be used as a box cutter and general purpose knife while the scraper position allows scraping and other uses where the orientation of the blade needs to be perpendicular to the handle.

### BACKGROUND OF THE INVENTION

Humans have been using knifes for thousands of years. Early knives were made of rock like flint and volcanic glass. Eventually humans gained the knowledge necessary to make knives from metals including brass, iron and eventually steel. Because of the ability to create sharp knives from metals, eventually knives were specially produced to meet particular needs.

A particular kind of knife is known as a utility knife or box cutter and is used for a variety of uses. It has a sturdy single edged razor type blade that is generally positioned parallel to the handle and can be used to open boxes, cut cardboard, drywall, Styrofoam etc. Another kind of tool that is very useful is a scraper. A scraper has the blade positioned perpendicular to the handle portion and can be used to remove paint, stickers, etc. While the blade portion of both of these tools is similar, because of the orientation of the blade, they are not easily used for both scraping and cutting applications. There is a need for a single tool that can be used as a utility knife as well as a scraper.

### SUMMARY OF THE INVENTION

A multi-use knife scraper has a handle portion which pivotally retains a blade holder at one end. A single-edged blade is held therein and can be positioned between a knife position which is generally parallel to the handle and a scraper position which is generally perpendicular to the handle. In one embodiment, the blade can be rotated to fit within the handle to secure the blade safely. One embodiment uses single-edged razor blades and another embodiment utilizes utility blades. The knife position allows the knife to be used as a box cutter and general purpose knife while the scraper position allows scraping and other uses where the orientation of the blade needs to be perpendicular to the handle.

Other features and advantages of the instant invention will become apparent from the following description of the invention which refers to the accompanying drawings.

### BRIEF DESCRIPTION OF THE DRAWINGS

FIG. 1 is a side view of a multi-use knife scraper according to an embodiment of the invention.

FIG. 2 is a side view with the blade rotated of the multi-use knife scraper shown in FIG. 1.

FIG. 3 is a side view of a multi-use knife scraper according to an embodiment of the invention.

FIG. 4 is a side view of the multi-use knife scraper shown in FIG. 3.

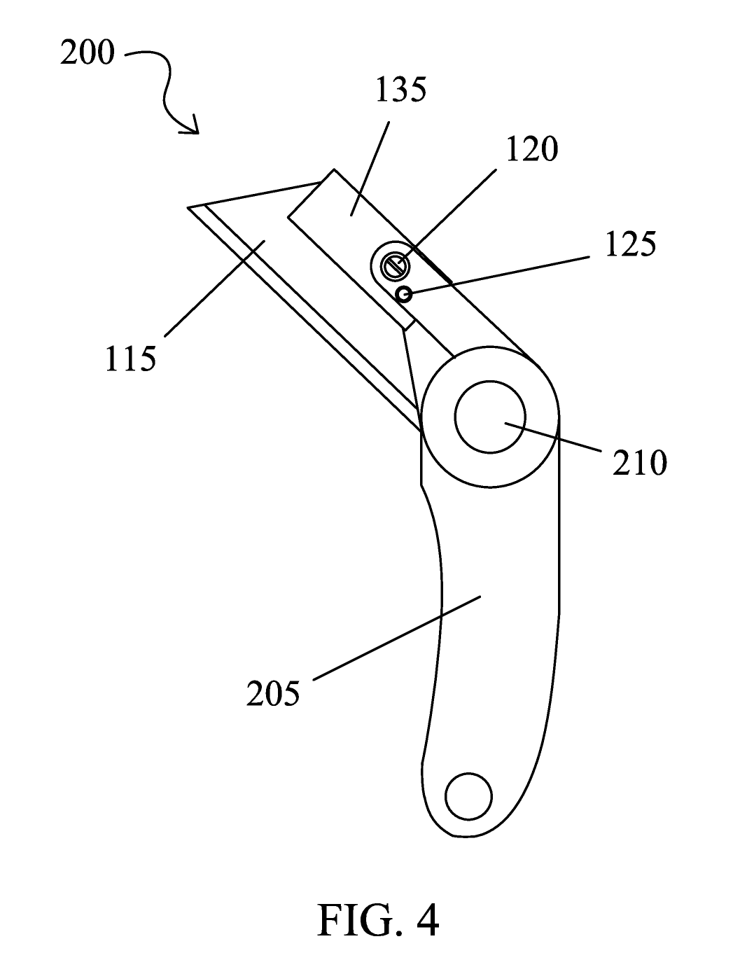

FIG. 5 is a side view of the multi-use knife scraper shown in FIG. 3.

FIG. 6 is a side view of the multi-use knife scraper shown in FIG. 3.

FIG. 7 is a side view of a multi-use knife scraper according to an embodiment of the invention.

FIG. 8 is a side view of the multi-use knife scraper shown in FIG. 7.

FIG. 9 is a side end view of the multi-use knife scraper shown in FIG. 7.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

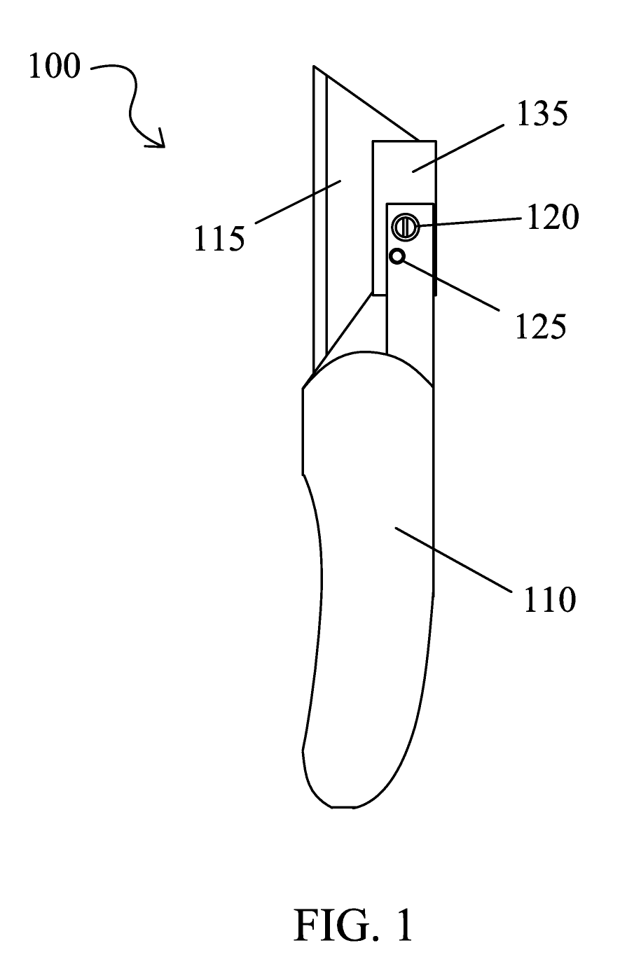

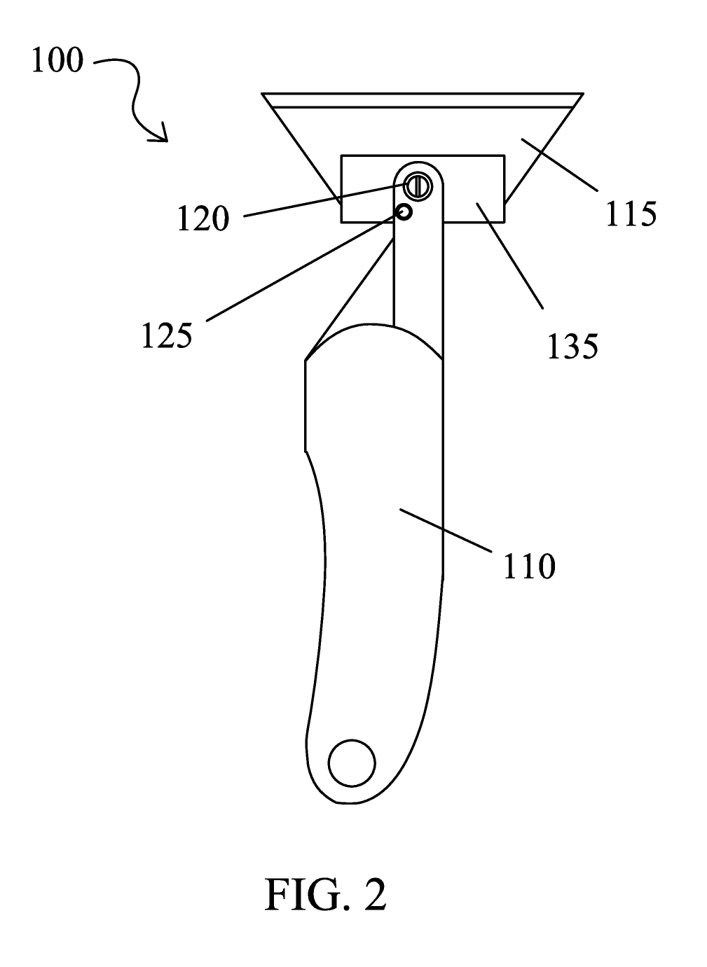

Referring to FIGS. 1 and 2, a multi-use knife scraper 100 is shown having a handle 110 that securely holds a blade holder 135. A blade 115 is held in place by compressing it between both sides of blade holder 135 and by engaging with a slot in blade 115 (not shown) as is known in the art. A pivot screw 120 is provided to allow blade 115 to rotate 90 degrees around its axis. In this embodiment, pivot screw 120 is used to hold blade 115 securely in place when tightened. Of course other means of securing blade 115 such as spring-biased detents, etc. may be used as is known in the art. A release detent button 125 is used to selectively lock blade 115 in place in the desired orientation. When in the first position shown (parallel to handle 110), multi-use knife scraper 110 is useful in the traditional utility knife functions such as cutting panels, boxes, sheet rock, cardboards etc. In the rotated position (perpendicular to handle 110), multi-use knife scraper is useful as a scraper.

Handle 110 is made of a high impact plastic material, but of course it could be made of any suitable material such as metal. Additionally, handle 110 may be coated with a rubberizing material to aid in handling. Of course blade holder 135 is shown as merely holding blade 115, but it can also be configured to allow quick changing on blade 115 (not shown) as is known in the art by adding moveable detents that securely hold blade 115 in place and then release when pressed to allow blade change.

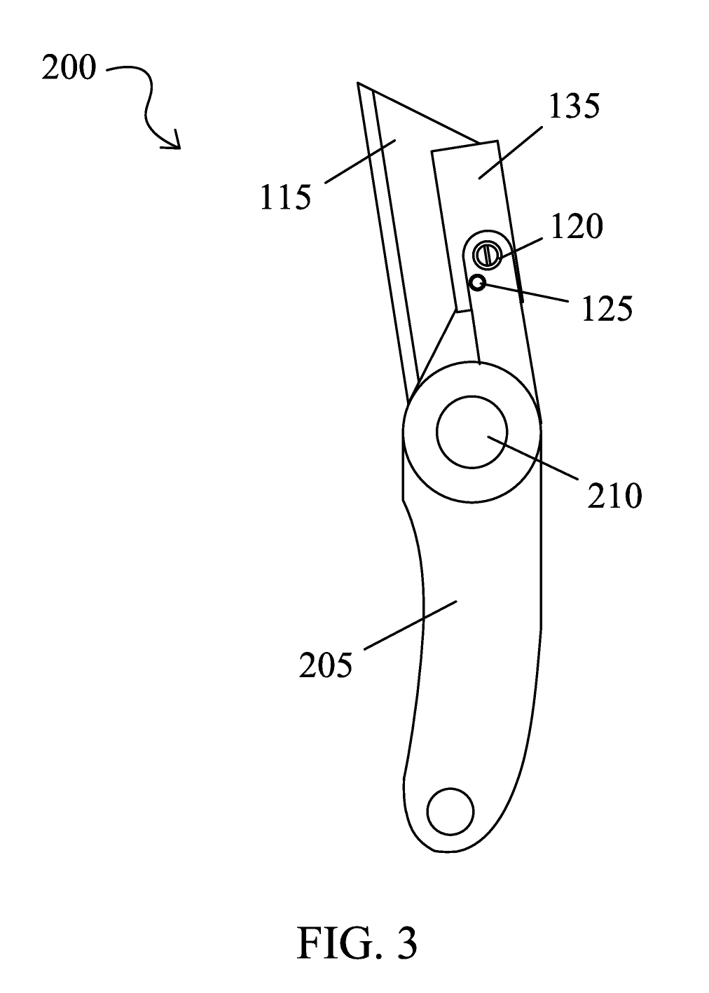

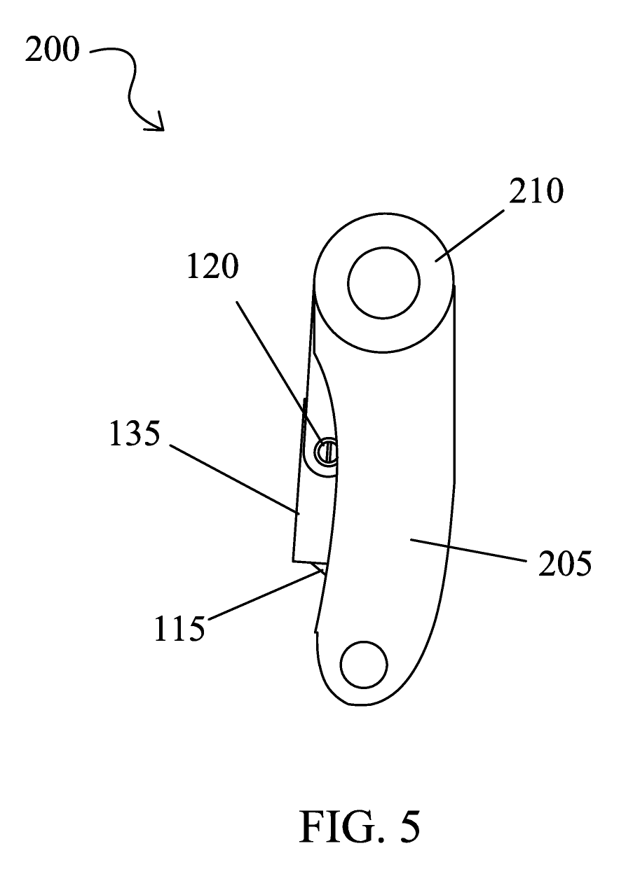

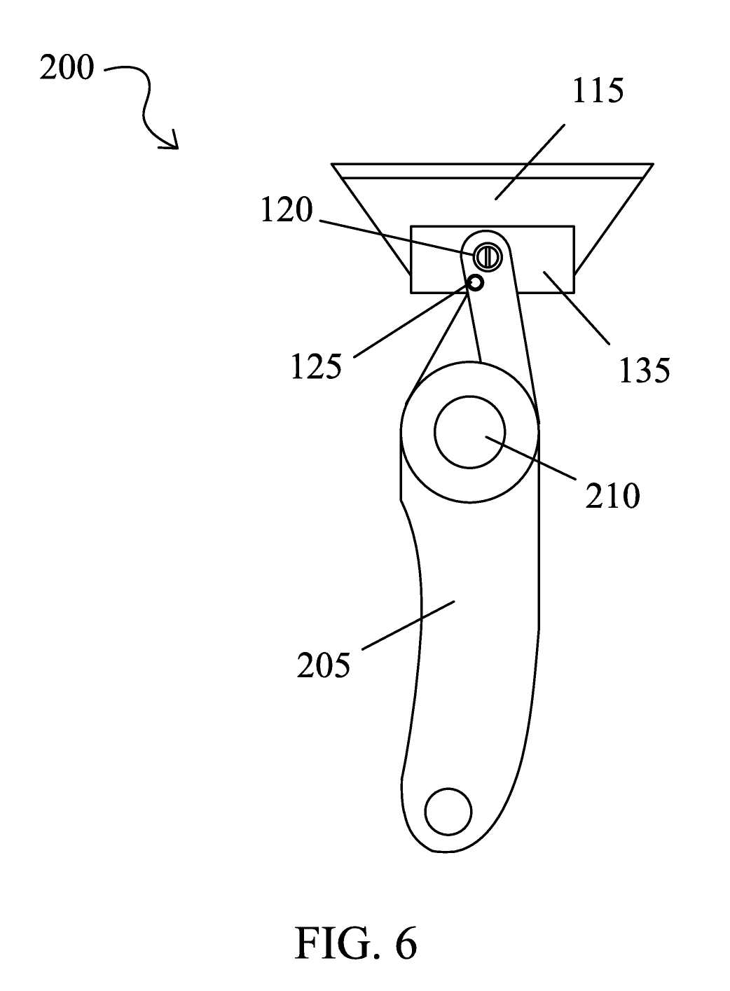

Referring now to FIGS. 3, through 6, a multi-use knife scraper 200 is shown having a handle 205 with a folding hinge 210. Blade holder 135 holds blade 115 and rotates around pivot retainer 120 as discussed above. Folding hinge 210 is used to allow blade 115 to be folded as shown in FIG. 5. As shown in FIG. 6, multi-use knife scraper 200 is shown in scraper orientation as discussed above.

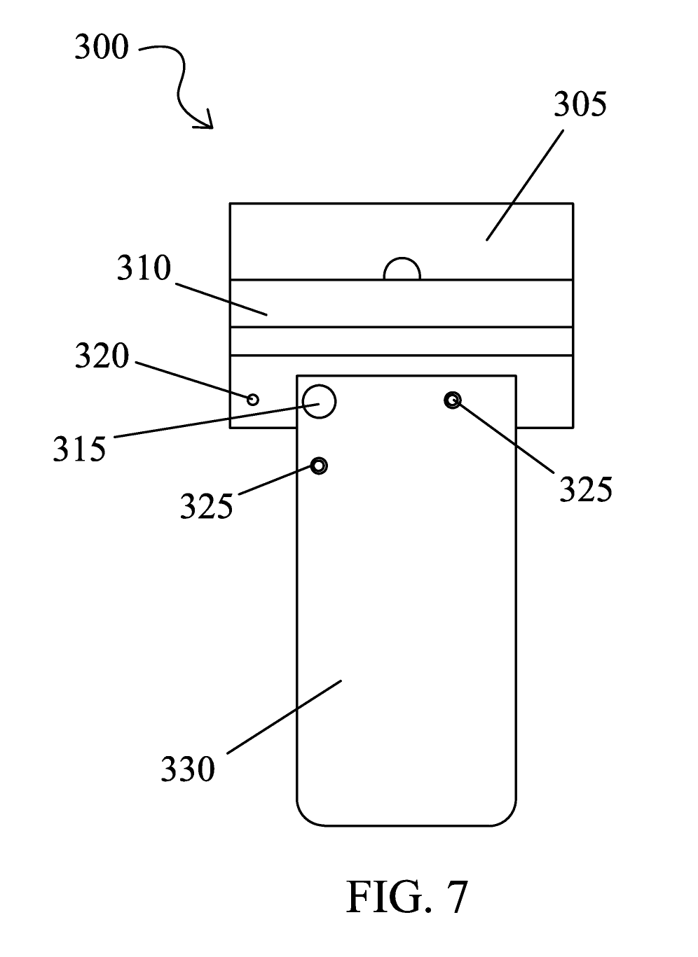

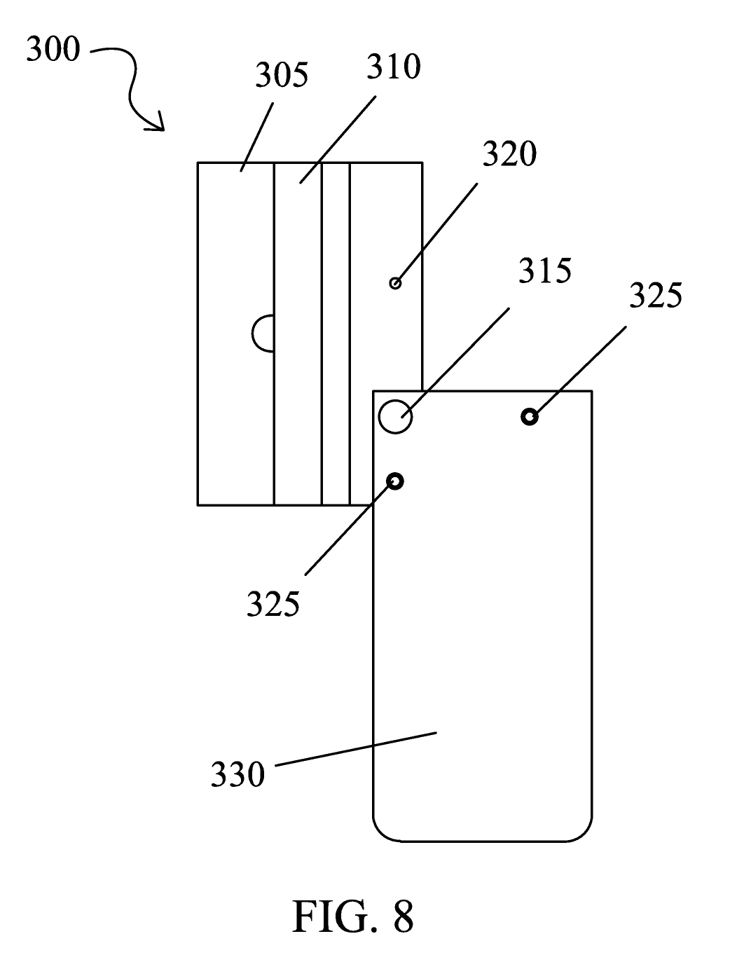

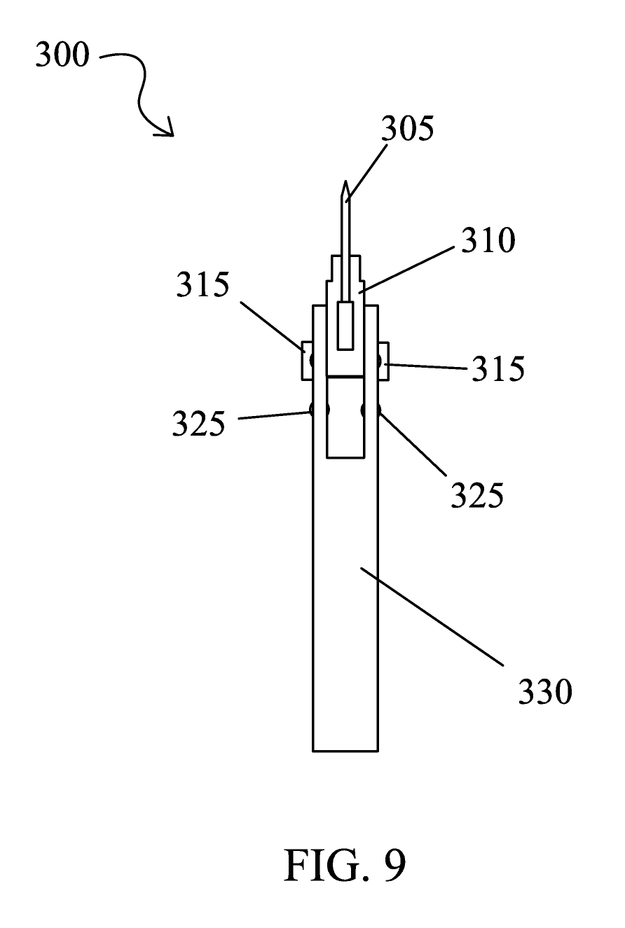

Referring now to FIGS. 7 through 9, a multi-use knife scraper 300 is shown having a handle 330 with a pivot retainer 315 which pivotally holds a blade holder 310. A single edged blade 305 is held securely in place by blade holder 310. Two positioning detents 325 are used to moveably secure blade 305 in knife mode and scraper mode. Two retaining detent catch openings 320 are provided to catch blade holder 310 in the desired orientation.

Other means for securing a blade are possible and should be considered to be within the disclosure of the instant invention as long as the blade can be pivoted from a standard knife generally parallel orientation to a scraper orientation which is generally perpendicular to the handle.

Although the instant invention has been described in relation to particular embodiments thereof, many other variations and modifications and other uses will become apparent to those skilled in the art.

What is claimed is:

1. A multi-use knife scraper comprising:
a handle;
a blade holder pivotally secured to a an end portion of said handle;
a blade removably secured within said blade holder where a sharp portion of said blade is exposed; and
a selector means for securing said blade in a selected orientation.

2. The multi-use knife scraper of claim 1 wherein said selector means is a detent.

3. The multi-use knife scraper of claim 1 wherein said selector means is a biased push button.

4. The multi-use knife scraper of claim 1 further comprising a folding hinge disposed between said blade holder and said handle whereby said blade is foldable within a blade hiding portion of said handle.

5. The multi-use knife scraper of claim 1 wherein said selected orientation is one of a scraper position or a knife position wherein said scraper position is generally perpendicular to said handle and wherein said knife position is generally parallel to said handle.

6. The multi-use knife scraper of claim 1 wherein said blade is a utility knife blade.

7. The multi-use knife scraper of claim 1 wherein said blade is a single-edged razor blade.
